(19) United States
(12) Patent Application Publication
(10) Pub. No.: US 2026/0107247 A1
(43) Pub. Date: Apr. 16, 2026

(54) REAL-TIME KINEMATIC POSITIONING ENABLED TELECOMMUNICATIONS NETWORKS

(71) Applicant: DISH Wireless L.L.C., Englewood, CO (US)

(72) Inventors: Mehdi Alasti, Arlington, VA (US); Sourabh Gupta, Ashburn, VA (US)

(21) Appl. No.: 18/916,165

(22) Filed: Oct. 15, 2024

(51) Int. Cl. H04W 64/00

(52) U.S. Cl. CPC H04W 64/00

(57) ABSTRACT

Technologies for real-time kinematic (RTK) positioning enabled telecommunications networks are described. One method includes receiving, from a cell tower of a cellular network, a set of data including global positioning satellite (GPS) signal data, wherein the cell tower corresponds to a fixed GPS receiver of a real-time kinematic (RTK) positioning system, generating, based on the set of data, RTK correction data, and causing the RTK correction data to be delivered to at least one user device of the cellular network using at least one delivery method, wherein the at least one user device corresponds to at least one mobile GPS receiver of the RTK positioning system, and wherein the at least one delivery method includes at least one of a broadcast delivery method, a multicast delivery method, or a unicast delivery method.

### BACKGROUND

A telecommunication network, such as a cellular network, can include a radio access network (RAN) that can enable communication with user equipment (UE). In particular, UE can communicate with a base station of the RAN. In a fifth generation (5G) wireless network (referred to as a “5G network”), the base station is referred to a Next Generation Node B, a “gNodeB,” or a “gNB.”

A radio unit (RU) is a component of a telecommunication network (e.g., of the RAN) that can transmit and receive radio signals to facilitate communication between the RAN and the UE. For example, an RU can convert digital baseband signals into radio frequency (RF) signals, and transmit the RF signals to UE. As another example, an RU can receive RF signals to UE, and convert the RF signals into digital baseband signals. Examples of RUs include part of multiple-input multiple-output (MIMO) RUs, small cell RUs, integrated RUs, etc.

### BRIEF DESCRIPTION OF THE SEVERAL VIEWS OF THE DRAWINGS

The present disclosure is illustrated by way of example, and not by way of limitation, in the figures of the accompanying drawings.

FIGS. 1A-1C are block diagrams of example telecommunications networks implementing real-time kinematic (RTK) positioning, according to some embodiments.

FIG. 2 is a diagram of an example multicast and broadcast services (MBS) architecture that can be used by telecommunications networks to deliver real-time kinematic (RTK) correction data to user devices of the telecommunications network via multicast or broadcast delivery, according to some embodiments.

FIG. 3 is a diagram of an example unicast services (USS) architecture that can be used by telecommunications networks to deliver real-time kinematic (RTK) correction data to user devices of the telecommunications network via unicast delivery, according to some embodiments.

FIGS. 4-5 are flow diagrams of example methods for implementing real-time kinematic (RTK) positioning within a telecommunications network, according to some embodiments.

FIG. 6 depicts a 5G network including a radio access network (RAN) and a core network, according to some embodiments.

FIG. 7 depicts an example radio access network (RAN) and a core network for providing a communications channel (or channel) between user equipment and data network, according to some embodiments.

FIGS. 8A-8B depict an example radio access network (RAN), according to some embodiments.

### DETAILED DESCRIPTION

Technologies for real-time kinematic (RTK) positioning enabled telecommunications networks are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular embodiments may vary from these exemplary details and still be contemplated to be within the scope of the present disclosure.

Global Positioning System (GPS) is a satellite-based navigation system that allows users to determine their precise location anywhere on Earth. GPS relies on a network of GPS satellites orbiting the Earth. Each GPS satellite continuously transmits signals containing its location and the precise time the signal was sent. A GPS receiver embedded within a device (e.g., mobile device) picks up signals from multiple GPS satellites.

To determine the position of a device including a GPS receiver, the GPS receiver can receive signals from multiple GPS satellites (e.g., at least four satellites), determine distance measurements to respective GPS satellites based on the received signals, and then determine the position based on the distance measurements. More specifically, the GPS receiver can calculate each distance to the respective GPS satellite based on how long it took for the signal to be received by the GPS receiver (i.e., the time delay). For example, the GPS receiver can determine a distance D from a GPS satellite using the formula D=c×T, where c is the speed of light and T is the time delay. With distance measurements from at least three GPS satellites, the GPS receiver can use trilateration to pinpoint its position in three-dimensional (3D) space (e.g., latitude, longitude, and altitude). A fourth GPS satellite can be used to perform time synchronization to correct any time discrepancies in the clock of the GPS receiver. This is because the clock of the GPS receiver may be less accurate than the atomic clocks used by GPS satellites.

Standard GPS accuracy can range between about 5 meters (m) to about 10 m. GPS accuracy can be influenced by a variety of factors, such as atmospheric conditions, GPS satellite geometry and/or orbit errors, signal blockage (buildings, trees, mountains, etc.), clock inaccuracies, other types of interference, etc. For example, the atmosphere around the Earth is created by several different layers each with different propagation speed for the electromagnetic waves, which can contribute to the inaccuracy of GPS positioning.

Differential GPS (DGPS) is an enhancement to standard GPS that improves the accuracy of position measurements. DGPS uses a network of fixed ground reference stations (“reference stations”) at known locations. These reference stations continuously receive GPS signals, and can determine differences between their known positions and the positions calculated from the GPS signals. These differences represents the errors in the GPS signals. The reference stations can generate correction data based on the observed errors and transmit these corrections to nearby DGPS receivers. These DGPS receivers then apply the corrections to their own GPS signal data, which can improve accuracy as compared to standard GPS. For example, DGPS can enhance GPS accuracy to less than about 5 m (e.g., less than or equal to about 3 m), depending on the system and conditions.

Real-time kinematic (RTK) positioning is another enhancement to standard GPS that improves the accuracy of position measurements. RTK positioning leverages the reference station principles of DGPS, but further implements carrier-phase signal measurements to provide real-time corrections. In particular, RTK positioning uses the phase of the carrier wave signals transmitted by GPS satellites, which is more precise than the measurements of pseudo-range signals that are transmitted by GPS satellites that are used for standard GPS and DGPS.

For example, an RTK position system can include a fixed GPS receiver (e.g., a base station) that is at a known location that can continuously receive carrier wave signals from GPS satellites, and a mobile GPS receiver (e.g., a rover unit) that receives the same carrier wave signals at a different location from the fixed GPS receiver. The fixed GPS receiver can measure the phase of the carrier wave signals to calculate a position, and determine the difference between the calculated position and its known position as correction data. The RTK correction data can then be sent to the mobile GPS receiver. The mobile GPS receiver can apply the RTK correction data to its own position calculations based on the received carrier wave signals, which can reduce errors and enable the mobile GPS receiver to achieve high accuracy in real time. By determining location based on carrier wave signals instead of pseudo-range signals, RTK positioning can be used to enhance GPS accuracy to less than about 10 centimeters (cm) (e.g., between about 2 cm to about 10 cm), depending on the system and conditions.

One solution for delivering RTK positioning signals is direct radio frequency (RF) connection, in which the fixed GPS receiver directly connects to the mobile GPS receiver wireless using RF signals. However, direct RF connections can suffer from various drawbacks including RF signal interference/degradation, and security vulnerabilities (e.g., direct RF connections may be more susceptible to eavesdropping and/or other unauthorized access)

Another solution for delivering RTK positioning signals is Networked Transport of RTCM (Radio Technical Commission for Maritime Services) via Internet Protocol (NTRIP). NTRIP is a protocol used to stream GPS data and/or GNSS (Global Navigation Satellite Systems) data as RTCM messages over the Internet. RTCM messages can include information about satellite positioning, corrections, and other relevant GPS data and/or GNSS data. NTRIP allows the transmission of real-time correction data, such as DGPS and RTK correction data, from a fixed GPS receiver to one or more mobile GPS receivers over the Internet. An NTRIP system can include one or more NTRIP servers that each collect raw correction data from one or more fixed GPS receivers, process the raw correction data, and send the processed correction data to one or more mobile GPS receivers as one or more NTRIP client devices. An NTRIP system can include an intermediary device (e.g., caster) that facilitates the connection between an NTRIP server and the one or more NTRIP client devices.

NTRIP systems are beneficial due to scalability (e.g., multiple NTRIP client devices can connect to a single NTRIP server), accessibility (e.g., Internet-based connectivity enables NTRIP client devices located in remote locations to access GPS/GNSS data), and cost-effectiveness (e.g., reduce the need for more expensive dedicated radio links for transmitting correct data). However, some drawbacks to NTRIP systems include Internet dependency (e.g., need for a reliable Internet connection and/or suitably high bandwidth for high-quality GPS/GNSS data), latency issues caused by transmission delay over the Internet (which can impact real-time performance for RTK positioning applications), security concerns due to transmitting data over the Internet without proper encryption, etc.

Aspects and embodiments of the present disclosure address these challenges by providing for RTK positioning enabled telecommunications networks. For example, embodiments described herein provide for a cellular network that enables cell-based delivering of RTK correction data to provide RTK positioning services.

In contrast to point-to-point connection systems that use a dedicated frequency to transmit RTK correction data to user devices corresponding to mobile GPS receivers via point-to-point connections, a system described herein can support delivery of the RTK correction data over the telecommunications network to user devices corresponding to mobile GPS receivers without point-to-point connections and/or using an NTRIP system. A system described herein does not confine user devices corresponding to mobile GPS receivers to specific spectrum bands utilized to enable point-to-point connections with the fixed GPS receiver (and such user devices may not be configured to support point-to-point connections). Instead, a system described herein can integrate RTK positioning as a service, that can be delivered alongside other network services, offering more flexibility and scalability. A system described herein has the option to map the RTK positioning service on a slice to a specific set of devices, or devices of a specific tenant/enterprise.

In some embodiments, the system delivers RTK correction data via unicast delivery. Unicast delivery generally includes sending data (e.g., packets) from a source (e.g., transmission point) to at least one destination user device (e.g., receiving point) on an individual basis, or one-to-one data delivery. For example, unicast delivery of RTK correction data can include sending RTK correction data from a fixed GPS receiver to a mobile GPS receiver that has requested the RTK correction data.

In some embodiments, the system delivers RTK correction data via multicast delivery. Multicast delivery generally includes sending data (e.g., packets) from a source to multiple destination user devices, or one-to-many data delivery. More specifically, the multiple user devices can form a multicast group. User devices can subscribe to the multicast group prior to receiving the data. That is, user devices that are not included in the multicast group may not be able to receive the data delivered via multicast. For example, multicast delivery of RTK correction data can include sending RTK correction data from a fixed GPS receiver to multiple mobile GPS receivers within a group.

In some embodiments, the system delivers RTK correction data via broadcast delivery. Broadcast delivery generally includes sending data (e.g., packets) from a source to all devices that have a receiver within a broadcast service area, or one-to-all data delivery. For example, broadcast delivery of RTK correction data can include sending RTK correction data from a fixed GPS receiver to all mobile GPS receivers with the broadcast service area. Accordingly, broadcast delivery can be used to transmit data to all user devices within a broadcast service area without having to subscribe to a multicast group.

An operator of the cellular network can allow users of the cellular network to subscribe and receive RTK correction data over a broadcast channel, multicast channel, or a list for unicast delivery.

For example, the cellular network can include a RAN including a base station (e.g., gNB tower or an associated RU close to the gNB tower in a 5G cellular network) equipped with a GPS receiver to function as a fixed GPS receiver of an RTK positioning system.

The cellular network can further include an RTK correction module, collocated with the RU, distributed unit (DU), centralized unit (CU), mobile edge computing (MEC), etc., to receive GPS signal data from the GPS receiver of the cell tower. The RTK correction module can further receive cell tower data identifying the location of the cell tower (e.g., a cell identifier (Cell-ID) of the cell tower identifying the latitude and longitude of the cell tower). However, the cell tower data can include any suitable location data in accordance with embodiments described herein. The RTK correction module can process the GPS signal data (and the cell tower data) to generate RTK correction data.

The cellular network can further include a positioning application programming interface (API). The positioning API can receive the RTK correction data from the RTK correction module, and deliver the RTK correction data to one or more user devices (e.g., UE) within a cell using a cell-specific broadcast, multicast, or unicast delivery. That is, the one or more user devices each function as a mobile GPS receiver of the RTK positioning system (e.g., rover). Each user device can be RTK-enabled to determine location and/or position based on the GPS signal data and the RTK correction data (via at least one of hardware, firmware, API(s), etc.). The base station (e.g., scheduler at MAC at DU) can periodically transmit the RTK correction data. In some embodiments, the positioning API delivers the RTK correction data using downlink control information (DCI) (e.g., Multi-Base Station (MBS) DCI). In some embodiments, the positioning API delivers the RTK correction data to each user device individually. In some embodiments, the RTK correction data is delivered (through broadcast, multicast, or unicast) to all user devices within the cell. In some embodiments, the correction data is delivered (through broadcast, multicast, or unicast) to a selection of user devices within the cell. In some embodiments, the RTK correction data is delivered (through broadcast, multicast, or unicast) to a single user device within the cell.

Embodiments described herein can be applied to various use cases. Examples of use cases include surveying and mapping (e.g., creating detailed maps and surveys with highly accurate location data), agriculture (e.g., precision farming using accurately mapped fields), construction (e.g., ensure that buildings are built to precise specifications and guiding heavy machinery), autonomous vehicles (e.g., using real-time position data to enable accurate and safe autonomous vehicle navigation), search and rescue (e.g., tracking and locating people in difficult to navigate environments), etc.

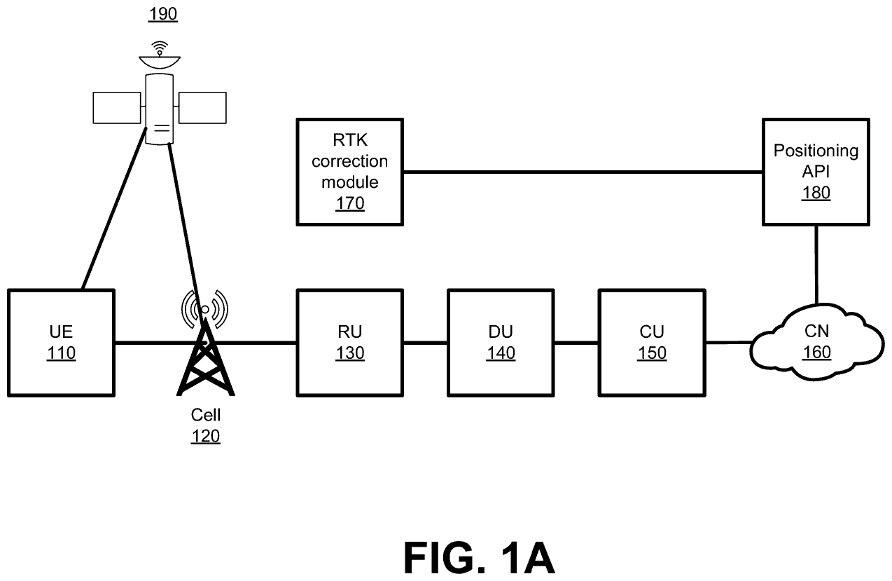

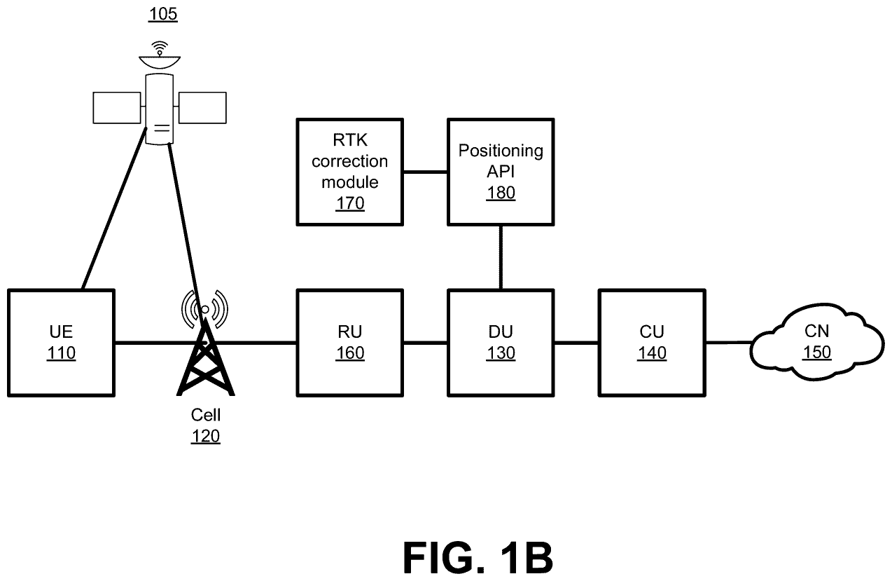

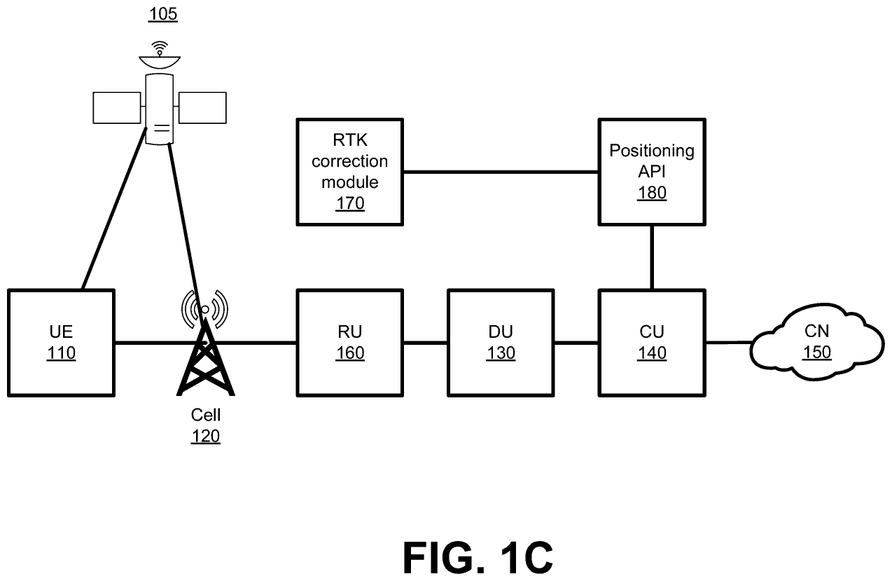

FIG. 1A is a diagram of an example system 100A including a telecommunications network implementing RTK positioning, according to some embodiments. For example, the telecommunications network can include a cellular network that enables cell-based delivery of RTK correction data (e.g., broadcast, multicast, or unicast) to provide RTK positioning services. An operator of the cellular network can allow users of the cellular network to subscribe and receive RTK correction data over a broadcast channel, multicast channel, or a list for unicast delivery. A subscriber can join a multicast group. Additionally, a DU can add a subscriber to a list that the scheduler at MAC/DU should deliver the RTK correction data through unicast delivery.

For example, as shown in FIG. 1A, the system 100A can include user equipment (UE) 110 and cell tower 120. The UE 110 can include an electronic device with wireless connectivity or cellular communication capability, such as a mobile phone or handheld computing device. The UE 110 can include any suitable computing device that can connect to the cell tower 120 via a wireless connection. For example, the UE 110 can include a mobile computing device. As another example, the UE 110 can include a non-mobile computing device. Examples of suitable computing devices that the UE 110 can include are laptop computers, desktop computers, Internet-of-Things (IoT) devices, and/or any other computing devices that include a wireless communications interface to communicate with the cell tower 120. The UE 110 can be one of a plurality of UEs (not depicted) that are in communication with the cell tower 120.

As further shown in FIG. 1A, the cell tower 120 can include a base station (e.g., cell site or cell tower). The base station is an element of the telecommunications network that is responsible for the transmission and reception of radio signals in one or more cells to or from UE 110. The RAN cell can include multiple base stations that each cover a respective coverage area. In some embodiments, the base station includes multiple base station components (e.g., antenna arrays), where each base station component of the base station provides coverage over a respective sector of the coverage area covered by the base station. For example, the base station can include three base station components (e.g., alpha, beta and gamma), where each base station component provides coverage over a respective 120° sector of the 360° coverage area covered by the base station. In some embodiments, the telecommunications network of the system 100AA is a 5G network. For example, the UE 110 can include a 5G smartphone or a 5G cellular device that connects to the cell tower 120 via a wireless connection, and the cell tower 120 can include a new-generation radio access network (NG-RAN) that uses the 5G new radio interface (NR), and the base station is a 5G base station (e.g., gNB tower). The UE 110 can gain initial access to the telecommunications network by communicating with the cell tower 120 through a random access channel (RACH).

As further shown in FIG. 1A, the system 100A can further include a set of network functions including a radio unit (RU) 130, a distributed unit (DU) 140, a centralized unit (CU) 150, and a core network (CN) 160. More specifically, the CN 160 can be a broadcast-enabled CN. At least one network function of the set of network functions can be virtualized within a remote (e.g., cloud) environment.

As further shown in FIG. 1A, the system 100A can further include an RTK correction module 170 and positioning API 180. The RTK correction module 170 can be collocated with any suitable component of the system 100A. For example, the RTK correction module 170 can be collocated with at least one of the RU 130, the DU 140, the CU 150, the CN 160, an MEC (not shown in FIG. 1A), etc.

The system 100A can include at least one GPS satellite 190. The at least one GPS satellite can transmit GPS signals. For example, the GPS signals can include pseudo-range signals and carrier wave signals.

The system 100A can implement RTK positioning based on GPS signals received from at least one GPS satellite 190 (e.g., the carrier wave signals). For example, the base station of the cell tower 120 can be equipped with a GPS receiver to function as a fixed GPS receiver of an RTK positioning system.

The RTK correction module 170 can receive a set of data including GPS signal data from the GPS receiver of the base station of the cell tower 120. In some embodiments, the set of data further includes cell tower data identifying the location of the base station of the cell tower 120 (e.g., a cell identifier (Cell-ID) of the cell tower identifying the latitude and longitude of the cell tower). However, the cell tower data can include any suitable location data in accordance with embodiments described herein. The RTK correction module 170 can process the set of data to generate RTK correction data.

The positioning API 180 can receive the RTK correction data from the RTK correction module, and deliver (through broadcast, multicast, or unicast) the RTK correction data to one or more user devices (e.g., the UE 110) within a cell using a cell-specific broadcast, multicast, or unicast delivery. That is, the one or more user devices (e.g., the UE 110) each function as a mobile GPS receiver of the RTK positioning system (e.g., rover). Each user device can be RTK-enabled to determine location and/or position based on the GPS signal data and the RTK correction data (via at least one of hardware, firmware, API(s), etc.). For example, each UE can have a component (e.g., software, firmware and/or hardware) that can be used to determine its location from the RTK correction data.

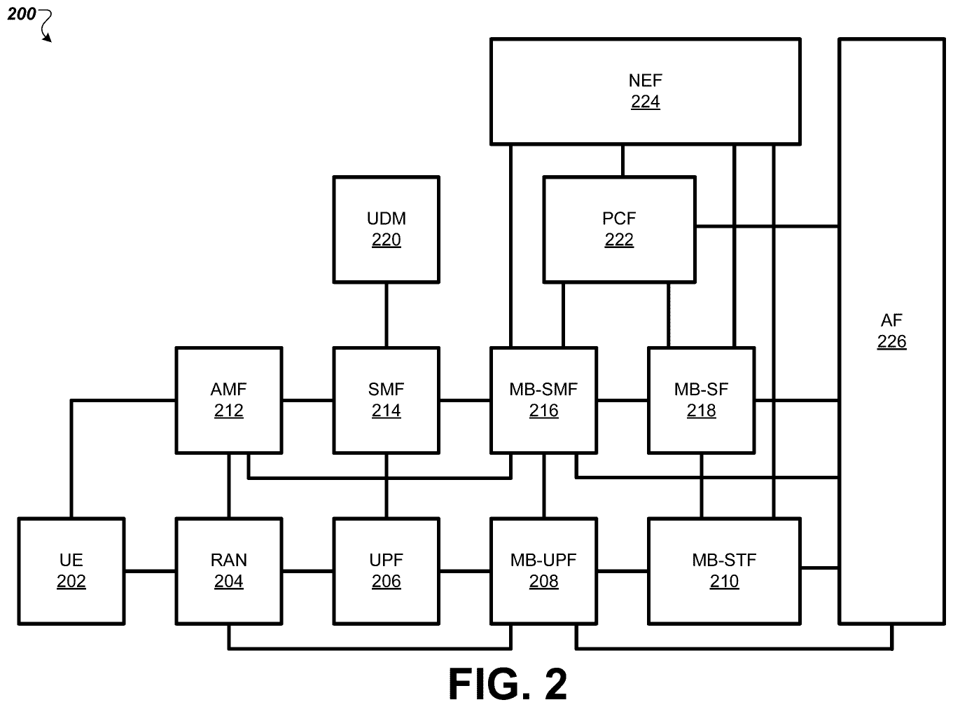

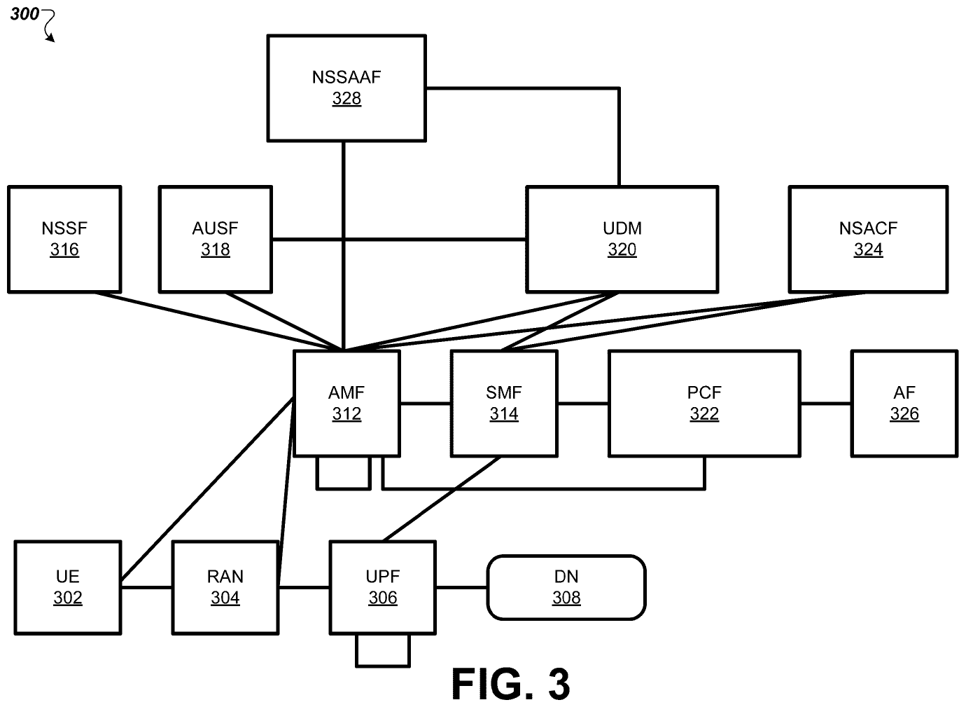

The base station of the cell tower 120 (e.g., scheduler at MAC at DU) can periodically transmit the RTK correction data. In some embodiments, the positioning API 180 delivers the RTK correction data using DCI (e.g., DCI 1_X unicast DCI or DCI 4_X MBS DCI). An example of a multicast or broadcast delivery system architecture is described below with reference to FIG. 2. An example of a unicast delivery system architecture is described below with reference to FIG. 3.

In some embodiments, the positioning API 180 delivers the RTK correction data (through broadcast, multicast, or unicast) to each user device (e.g., UE 110) individually. In some embodiments, the RTK correction data is delivered (through broadcast, multicast, or unicast) to all user devices within the cell. In some embodiments, the RTK correction data is delivered (through broadcast, multicast, or unicast) to a selection of user devices within the cell. In some embodiments, the RTK correction data is delivered to a single user device within the cell. In this illustrative example, the positioning API 180 is in communication with the CN 160. In some embodiments, the positioning API 180 is in communication with a different component. For example, as will now be described below with reference to FIG. 2, the positioning API 180 can be in communication with the DU.

FIG. 1B is a diagram of a system 100B including a telecommunications network implementing RTK positioning, according to some embodiments. The system 100B includes components 110-190 as described above with reference to FIG. 1A. In the example shown in FIG. 1B, the positioning API 180 is in communication with the DU 130, and the positioning API 180 can send cell-specific data to the DU 140. Further details regarding the components 110-190 of system 100B are described above with reference to FIG. 1A.

FIG. 1C is a diagram of a system 100C including a telecommunications network implementing RTK positioning, according to some embodiments. The system 100C includes components 110-190 as described above with reference to FIG. 1A. In the example shown in FIG. 1C, the positioning API 180 is in communication with the CU 130, and the positioning API 180 can send cell-specific data to the CU 130. Further details regarding the components 110-190 of system 100C are described above with reference to FIG. 1A.

FIG. 2 is a diagram of an example multicast and broadcast services (MBS) architecture 200 that can be used by a telecommunications network (e.g., the telecommunications network of FIGS. 1A-1C) to deliver RTK correction data to user devices of the telecommunications network via multicast or broadcast delivery, according to some embodiments. For example, the MBS architecture 200 can be implemented within a core network, such as the CN 150 of FIGS. 1A-1C. As shown in FIG. 2, the MBS architecture 200 can include UE 202, RAN 204, User Plane Function (UPF) 206, Multicast/Broadcast UPF (MB-UPF) 208, Multicast/Broadcast Service Transport Function (MB-STF) 210, Access and Mobility Function Management (AMF) 212, Session Management Function (SMF) 214, Multicast/Broadcast SMF (MB-SMF) 216, Multicast/Broadcast Service Function (MB-SF) 218, Unified Data Management (UDM) 220, Policy Control Function (PCF) 222, Network Exposure Function (NEF) 224 and Application Function (AF) 226.

The UPF 206 can route traffic to multiple UEs. The MB-UPF 208 can forward multicast/broadcast data through a single transmission to the RAN 204, which can distribute it to multiple UEs including the UE 202. The RAN 204 can transmit multicast/broadcast traffic using a common Point-to-Multipoint (PTM) radio bearer, allowing multiple UEs to receive the data simultaneously using a suitable DCI format. The transmission of the multicast/broadcast data can be periodical.

FIG. 3 is a diagram of an example unicast services (US) architecture 300 that can be used by a telecommunications network (e.g., the telecommunications network of FIGS. 1A-1C) to deliver RTK correction data to user devices of the telecommunications network via unicast delivery, according to some embodiments. For example, the US architecture 300 can be implemented within a core network, such as the CN 150 of FIGS. 1A-1C. As shown in FIG. 3, the US architecture 300 can include UE 302, RAN 304, UPF 306, Destination Network (DN) 308, AMF 312, SMF 314, Network Slice Selection Function (NSSF) 316, Authentication Server Function (AUSF) 318, UDM 320, PCF 322, Network Slice Admission Control Function (NSACF) 224, AF 326, and Network Slice-Specific Authentication and Authorization Function (NSSAAF) 328.

The UPF 306 can route unicast traffic to the UE 302 over a dedicated Packet Data Unit (PDU) session with specific 5G quality of service (5QI). From the UPF 306 to the RAN 304, the traffic can be encapsulated in GTP-U (General Packet Radio Service (GPRS) Tunneling Protocol-User Plane) tunnels. The RAN 304 can send the data over a specific radio bearer to the UE 302, over a dedicated radio link. On the downlink, the RAN 304 can use a suitable DCI format.

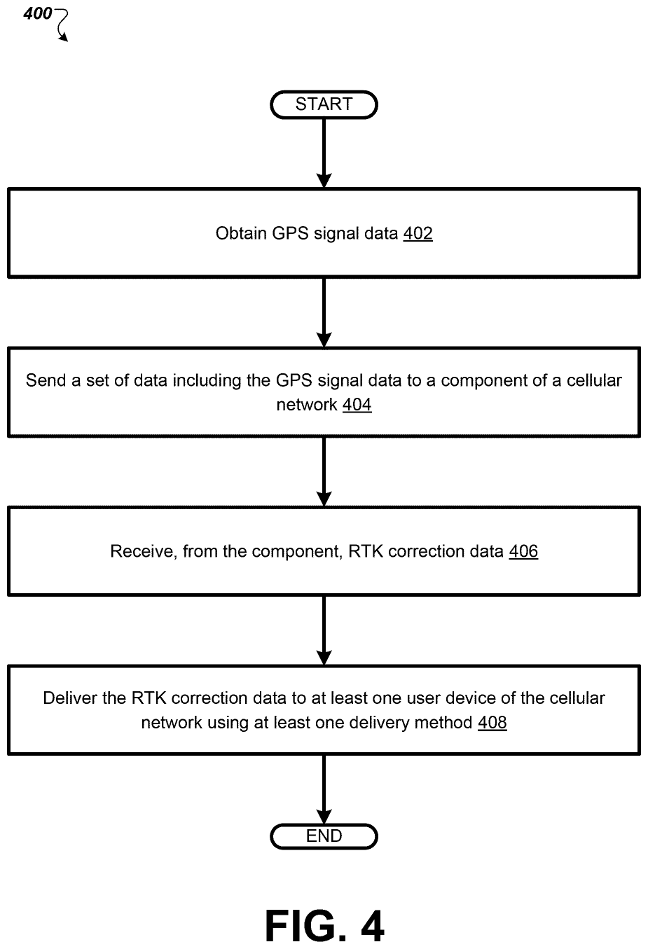

FIG. 4 is a flow diagram of a method 400 for implementing real-time kinematic (RTK) positioning within a telecommunications network, according to some embodiments. Method 400 may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, method 400 may be performed, in part, by components of system 100A. Method 400 may be performed by the cell tower 120 of FIG. 1 and/or the cell 220 of FIG. 2. In some embodiments, a non-transitory machine-readable storage medium stores instructions that when executed by a processing device (e.g., the cell tower 120 including the base station of FIG. 1 or the cell tower 120 including the base station of FIG. 2) cause the processing device to perform method 400. For example, the processing device can be included in a fixed GPS receiver of an RTK positioning system. For simplicity of explanation, method 400 is depicted and described as a series of operations. However, operations in accordance with this disclosure can occur in various orders and/or concurrently and with other operations not presented and described herein. Furthermore, not all illustrated operations may be performed to implement method 400 in accordance with the disclosed subject matter. In addition, those skilled in the art will understand and appreciate that method 400 could alternatively be represented as a series of interrelated states via a state diagram or events.

At operation 402, processing logic obtains GPS signal data. For example, obtaining the GPS signal data can receiving a set of GPS signals from at least one GPS satellite. The set of GPS signals can include at least one carrier wave signal. The set of GPS signals can further include at least one pseudo-range signal.

At operation 404, processing logic sends a set of data including the GPS signal data to a component of a cellular network. The component can implement and/or include an RTK correction module. For example, the component can be an RU, a DU, a CU, an MEC, etc. In some embodiments, the set of data further includes cell tower data identifying the location of the base station. For example, the cell tower data can include Cell-ID of the cell tower identifying the latitude and longitude of the cell tower. However, the cell tower data can include any suitable location data in accordance with embodiments described herein.

At operation 406, processing logic receives, from the component, RTK correction data. For example, the RTK correction data can be used by a mobile GPS receiver to determine a location of the mobile GPS receiver.

At operation 408, processing logic delivers the RTK correction data to at least one user device (e.g. mobile device) of the cellular network using at least one delivery method. The at least one delivery method can include at least one of a broadcast delivery method, a multicast delivery method, or a unicast delivery method. More specifically, the at least one user device can be associated with a cell. For example, the at least one user device can include at least one UE. Each user device can be equipped with a GPS receiver to function as a mobile GPS receiver of the RTK positioning system. Each user device can be RTK-enabled to determine location and/or position based on the GPS signal data and the correction data (via at least one of hardware, firmware, API(s), etc.). In some embodiments, delivering (through broadcasting/multicasting or unicasting) the RTK correction data to the at least one user device includes using a positioning API to deliver the RTK correction data to the at least one user device. In some embodiments, processing logic periodically transmits the RTK correction data. In some embodiments, delivering the RTK correction data to the at least one user device includes using DCI (e.g., DCI 1_X or DCI 4_X MBS DCI). In some embodiments, the RTK correction data is delivered (e.g., through broadcast, multicast, or unicast) to each user device individually. In some embodiments, the RTK correction data is delivered to all user devices within the cell. In some embodiments, the RTK correction data is delivered to a selection of user devices within the cell. In some embodiments, the RTK correction data is delivered to a single user device within the cell. Further details regarding operations 402-408 are described above with reference to FIGS. 1-3.

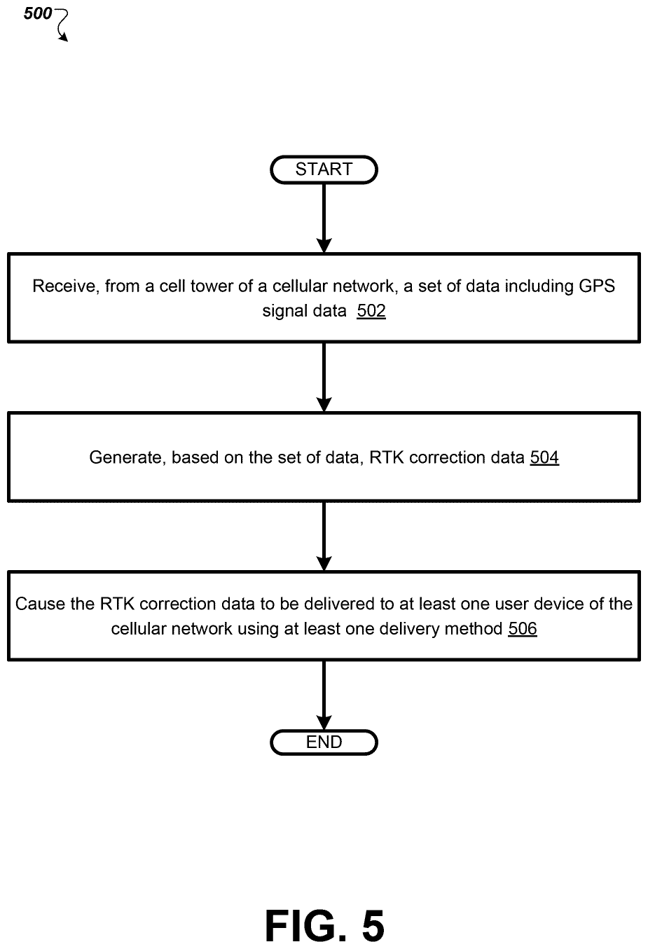

FIG. 5 is a flow diagram of a method 500 for implementing real-time kinematic (RTK) positioning within a telecommunications network, according to some embodiments. Method 500 may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, method 500 may be performed, in part, by components of system 100A. Method 500 may be performed by a component implementing an RTK correction module (e.g., the RTK correction module 170 of FIG. 1 and/or the RTK correction module 270 of FIG. 2. In some embodiments, a non-transitory machine-readable storage medium stores instructions that when executed by a processing device (e.g., the guest operator) cause the processing device to perform method 500. For simplicity of explanation, method 500 is depicted and described as a series of operations. However, operations in accordance with this disclosure can occur in various orders and/or concurrently and with other operations not presented and described herein. Furthermore, not all illustrated operations may be performed to implement method 500 in accordance with the disclosed subject matter. In addition, those skilled in the art will understand and appreciate that method 500 could alternatively be represented as a series of interrelated states via a state diagram or events.

At operation 502, processing logic receives, from a cell tower of a cellular network, a set of data including GPS signal data. The GPS signal data can be generated by the cell tower, as a fixed GPS receiver of an RTK positioning system, based on a set of GPS signals received from at least one GPS satellite. The set of GPS signals can include at least one carrier wave signal. The set of GPS signals can further include at least one pseudo-range signal. In some embodiments, the set of data further includes cell tower data identifying the location of the cell tower. For example, the cell tower data can include Cell-ID of the cell tower identifying the latitude and longitude of the cell tower. However, the cell tower data can include any suitable location data in accordance with embodiments described herein.

At operation 504, processing logic generates, based on the set of data, RTK correction data. In some embodiments, generating the RTK correction data includes identifying the location of the cell tower from the cell tower data, and using the GPS signal data and the location of the cell tower to generate the RTK correction data. For example, identifying the location of the cell tower from the cell tower data can include mapping the Cell-ID of the cell tower to the precise location of the cell tower.

At operation 506, processing logic causes the RTK correction data to be delivered to at least one user device (e.g., mobile device) of the cellular network using at least one delivery method. The at least one delivery method can include at least one of a broadcast delivery method, a multicast delivery method, or a unicast delivery method. More specifically, the at least one user device can be associated with a cell. For example, the at least one user device can include at least one UE. Each user device can be equipped with a GPS receiver to function as a mobile GPS receiver of the RTK positioning system. Each user device can be RTK-enabled to determine location and/or position based on the GPS signal data and the correction data (via at least one of hardware, firmware, API(s), etc.). In some embodiments, causing the RTK correction data to be delivered (through broadcast, multicast, or unicast) to the at least one user device includes causing a positioning API to broadcast the RTK correction data to the at least one user device. For example, causing the positioning API to deliver (through broadcast, multicast, or unicast) the RTK correction data to the at least one user device can include providing a set of broadcast, multicast, or unicast data including the RTK correction data to the positioning API. In some embodiments, the set of broadcast, multicast, or unicast data further includes the cell tower cell tower data (e.g., the Cell-ID of the cell tower). In some embodiments, processing logic periodically transmits the RTK correction data. In some embodiments, causing the RTK correction data to be delivered (through broadcast, multicast, or unicast) to the at least one user device includes using downlink control information (DCI) (e.g., DCI 1_X unicast or DCI 4_X MBS DCI). In some embodiments, the RTK correction data is delivered (through broadcast, multicast, or unicast) to each user device individually. In some embodiments, the RTK correction data is delivered (through broadcast, multicast, or unicast) to all user devices within the cell. In some embodiments, the RTK correction data is delivered (through broadcast, multicast, or unicast) to a selection of user devices within the cell. In some embodiments, the RTK correction data is delivered (through broadcast, multicast, or unicast) to a single user device within the cell. Further details regarding operations 502-506 are described above with reference to FIGS. 1A-4.

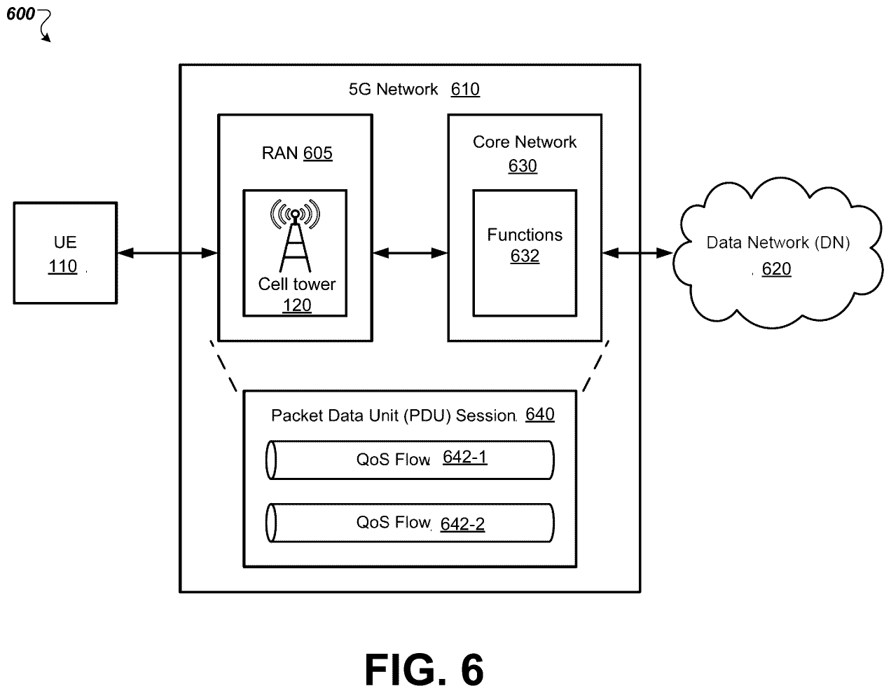

FIG. 6 depicts a 5G network 610 including the cell tower 120 of a radio access network (RAN) 605, according to at least one embodiment. The cell tower 120 can be similar to the cell tower 120 of FIGS. 1A-1B. The RAN 605 can include a new-generation radio access network (NG-RAN) that uses the 5G new radio interface (NR). The 5G network 610 connects the UE 110 to a data network (DN) 620 using the cell tower 120 and a core network 630. The DN 620 can include the Internet, a local area network (LAN), a wide area network (WAN), a private data network, a wireless network, a wired network, or a combination of networks. The UE 110 can include an electronic device with wireless connectivity or cellular communication capability, such as a mobile phone or handheld computing device. In at least one example, the UE 110 can include a 5G smartphone or a 5G cellular device that connects to the cell tower 120 via a wireless connection.

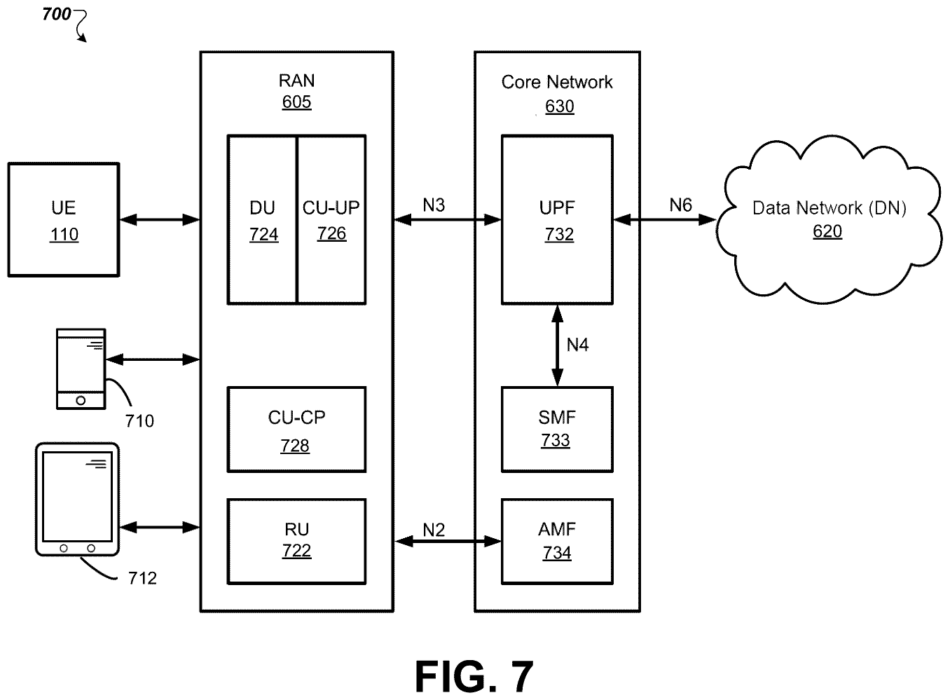

The RAN 605 can connect the UE 110 to the core network 630. As will be described in further detail below with reference to FIG. 7, the RAN 605 can include at least one radio unit (RU) for wirelessly communicating with the UE 110. An RU can include one or more radio transceivers for wirelessly communicating with UE 110. The at least one RU may include circuitry for converting signals sent to and from an antenna of the cell tower of the base station into digital signals for transmission over packet networks.

The core network 630 may utilize a cloud-native service-based architecture (SBA) in which different core network functions (e.g., authentication, security, session management, and core access and mobility functions) are virtualized and implemented as loosely coupled independent services that communicate with each other, for example, using hypertext transfer protocol (HTTP) (e.g., HTTP2) and application programming interfaces (APIs). In at least one embodiment, an architecture in which software is composed of small independent services that communicate over well-defined APIs may be used for implementing some of the core network functions. For example, control plane (CP) network functions for performing session management may be implemented as containerized applications. A container-based embodiment may offer improved scalability and availability over other approaches.

Core network functions (“functions”) 632 of core network can include an access and mobility management function (AMF), a session management function (SMF), and a user plane function (UPF). In at least one embodiment, the intelligent data collector can be implemented in the AMF. The UPF may perform packet processing including routing and forwarding, quality of service (QoS) handling, and packet data unit (PDU) session management. The UPF may serve as an ingress and egress point for user plane traffic and provide anchored mobility support for user equipment. For example, the UPF may provide an anchor point between the UE 110 and the DN 620 as the UE 110 moves between coverage areas. The AMF may act as a single-entry point for UE connection and perform mobility management, registration management, and connection management between a data network and the UE 110. The SMF may perform session management, user plane selection, and internet protocol (IP) address allocation. Functions 632 can include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, and an application function (AF) for providing application services. Application-level session information may be exchanged between the AF and PCF (e.g., bandwidth requirements for QoS). In some cases, when user equipment requests access to resources, such as establishing a PDU session or a QoS flow, the PCF may dynamically decide if the user equipment should grant the requested access based on a location of the user equipment. Further details regarding the functions 632 will be described below with reference to FIG. 7.

The 5G network 610 may provide one or more network slices, where each network slice may include a set of network functions that are selected to provide telecommunications services. For example, each network slice can include a configuration of network functions, network applications, and underlying cloud-based compute and storage infrastructure. In some cases, a network slice may correspond with a logical instantiation of a 5G network, such as an instantiation of the 5G network 610. In some cases, the 5G network 610 may support customized policy configuration and enforcement between network slices per service level agreements (SLAs). User equipment, such as UE 110, may connect to multiple network slices at the same time (e.g., eight different network slices). In one embodiment, a PDU session, such as PDU session 640, may belong to only one network slice instance.

A network slice can include an independent end-to-end logical communications network that includes a set of logically separated virtual network functions. Network slicing may allow different logical networks or network slices to be implemented using the same compute and storage infrastructure. Therefore, network slicing may allow heterogeneous services to coexist within the same network architecture via allocation of network computing, storage, and communication resources among active services. In some cases, the network slices may be dynamically created and adjusted over time based on network requirements. For example, some networks may require ultra-low-latency or ultra-reliable services. To meet ultra-low-latency requirements, components of the RAN 605, such as a distributed unit (DU) and a centralized unit (CU), may need to be deployed at a base station or in a local data center (LDC) that is in close proximity the cell tower such that the latency requirements are satisfied (e.g., such that the one-way latency from the cell tower to the DU component or CU component is less than 1.2 milliseconds (ms)). In some embodiments, the DU and the CU of the RAN 605 may be co-located with the RU. In other embodiments, the DU and the RU may be co-located at a cell site and the CU may be located within a local data center (LDC).

In some cases, the 5G network 610 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

The core network 630 may include a set of network elements that are configured to offer various data and telecommunications services to subscribers or end users of user equipment, such as UE 110. Examples of network elements include network computers, network processors, networking hardware, networking equipment, routers, switches, hubs, bridges, radio network controllers, gateways, servers, virtualized network functions and/or containerized network functions, and network functions infrastructure (e.g., virtualization or containerization infrastructure). A network element can include a real or virtualized or containerized component that provides wired or wireless communication network services.

Virtualization allows virtual hardware to be created and decoupled from the underlying physical hardware. One example of a virtualized component is a virtual router (or a vRouter). Another example of a virtualized component is a virtual machine. A virtual machine can include a software embodiment of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk.

The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64 GB virtual disk) for the virtual machine. Another example of a virtualized component is a software container or an application container that encapsulates an application's environment.

In some embodiments, applications and services may be run using virtual machines instead of containers in order to improve security. A common virtual machine may also be used to run applications and/or containers for a number of closely related network services.

The 5G network 610 may implement various network functions, such as the functions 632 and radio access network functions, using a cloud-based compute and storage infrastructure. A network function may be implemented as a software instance running on hardware or as a virtualized network function. Virtual network functions (VNFs) or containerized network functions (CNFs) can include embodiments of network functions as software processes or applications. In at least one example, a VNF or a CNF may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

The 5G network 610 may connect the UE 110 to the DN 620 using a PDU session 640, which can include part of an overlay network. The PDU session 640 may utilize one or more quality of service (QoS) flows, such as QoS flows 605 and 606, to exchange traffic (e.g., data and voice traffic) between the UE 110 and the DN 620. The one or more QoS flows can include the finest granularity of QoS differentiation within the PDU session 640. The PDU session 640 may belong to a network slice instance through the 5G network 610. To establish user plane connectivity from the UE 110 to the DN 620, an AMF that supports the network slice instance may be selected and a PDU session via the network slice instance may be established. In some cases, the PDU session 640 may be of type IPv4 or IPv6 for transporting IP packets. The RAN 605 may be configured to establish and release parts of the PDU session 640 that cross the radio interface.

The RAN 605 may include a set of one or more RUs that includes radio transceivers (or combinations of radio transmitters and receivers) for wirelessly communicating with UEs. The set of RUs may correspond with a network of cells (or coverage areas) that provide continuous or nearly continuous overlapping service to UEs, such as UE 110, over a geographic area. Some cells may correspond with stationary coverage areas and other cells may correspond with coverage areas that change over time (e.g., due to movement of a mobile RU). In some cases, the UE 110 may be capable of transmitting signals to and receiving signals from one or more RUs within the network of cells over time. One or more cells may correspond with a base station. The cells within the network of cells may be configured to facilitate communication between UE 110 and other UEs and/or between UE 110 and a data network, such as DN 620. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mmWave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

The UPF may be responsible for routing and forwarding user plane packets between the RAN 605 and the DN 620. Uplink packets arriving from the RAN 605 may use a general packet radio service (GPRS) tunneling protocol (or GTP) to reach the UPF. The GPRS tunneling protocol for the user plane may support multiplexing of traffic from different PDU sessions by tunneling user data over the interface between the RAN 605 and the UPF.

The UPF may remove the packet headers belonging to the GTP tunnel before forwarding the user plane packets towards the DN 620. As the UPF may provide connectivity towards other data networks in addition to the DN 620, the UPF must ensure that the user plane packets are forwarded towards the correct data network. Each GTP tunnel may belong to the PDU session 640. The PDU session 640 may be set up towards a data network name (DNN) that uniquely identifies the data network to which the user plane packets should be forwarded. The UPF may keep a record of the mapping between the GTP tunnel, the PDU session, and the DNN for the data network to which the user plane packets are directed.

Downlink packets arriving from the DN 620 are mapped onto at least one quality of service (QoS) flow belonging to the PDU session 640 before forwarded towards the appropriate cell tower 120. A QoS flow may correspond with a stream of data packets that have equal QoS. In some embodiments, and as sown in FIG. 6, multiple QoS flows including QoS flow 642-1 and 642-2 can belong to the PDU session 640. The UPF may use a set of service data flow (SDF) templates to map each downlink packet onto a respective QoS flow. The UPF may receive the set of SDF templates from a session management function (SMF), such as the SMF, during setup of the PDU session 640. The SMF may generate the set of SDF templates using information provided from a policy control function (PCF), such as the PCF. The UPF may track various statistics regarding the volume of data transferred by each PDU session, such as PDU session 640, and provide the information to an SMF.

FIG. 7 depicts a RAN 605 and a core network 630 for providing a communications channel (or channel) between user equipment and DN 620 according to at least one embodiment. In at least one embodiment, the at least one resource allocator 170 can be implemented in the cell tower 120. The communications channel can include a pathway through which data is communicated between the UE 110 and the DN 620. The UE in communication with the RAN 605 includes UE 110, mobile phone 710, and mobile computing device 712. The UE may include a set of electronic devices, including mobile computing device and non-mobile computing device.

The core network 630 includes core network functions such as UPF 732, SMF 733 and AMF 734, as described above with reference to FIG. 6. For example, the AMF 734 may interface with user equipment and act as a single-entry point for a UE connection. The AMF 734 may interface with the SMF to track user sessions. The AMF 734 may interface with a network slice selection function (NSSF) not depicted to select network slice instances for user equipment, such as UE 110. When user equipment is leaving a first coverage area and entering a second coverage area, the AMF 734 may be responsible for coordinating the handoff between the coverage areas whether the coverage areas are associated with the same radio access network or different radio access networks.

The UPF 732 may transfer downlink data received from the DN 620 to user equipment, such as UE 110, via the RAN 605 and/or transfer uplink data received from user equipment to the DN 620 via the RAN 605. An uplink can include a radio link though which user equipment transmits data and/or control signals to the RAN 605. A downlink can include a radio link through which the RAN 605 transmits data and/or control signals to the UE 110.

The RAN 605 may be logically divided into an RU 722, a DU 724, and a CU that is partitioned into a CU user plane portion (CU-UP) 726 and a CU control plane portion (CU-CP) 728. The CU-UP 726 may correspond with the centralized unit for the user plane and the CU-CP 728 may correspond with the centralized unit for the control plane. The CU-CP 728 may perform functions related to a control plane, such as connection setup, mobility, and security. The CU-UP 726 may perform functions related to a user plane, such as user data transmission and reception functions.

Decoupling control signaling in the control plane from user plane traffic in the user plane may allow the UPF 732 to be positioned in close proximity to the edge of a network compared with the AMF 734. In at least one embodiment, the intelligent data collector 106 can be implemented in the AMF 734. As a closer geographic or topographic proximity may reduce the electrical distance, this means that the electrical distance from the UPF 732 to the UE 110 may be less than the electrical distance of the AMF 734 to the UE 110. The RAN 605 may be connected to the AMF 734, which may allocate temporary unique identifiers, determine tracking areas, and select appropriate policy control functions (PCFs) for user equipment, via an N2 interface. The N3 Interface may be used for transferring user data (e.g., user plane traffic) from the RAN 605 to the user plane function UPF 732 and may be used for providing low-latency services using edge computing resources. The electrical distance from the UPF 732 (e.g., located at the edge of a network) to user equipment, such as UE 110, may impact the latency and performance services provided to the user equipment. The UE 110 may be connected to the SMF 733 via an N1 interface not depicted, which may transfer UE information directly to the AMF 734. The UPF 732 may be connected to the DN 620 via an N6 interface. The N6 interface may be used for providing connectivity between the UPF 732 and other external or internal data networks (e.g., to the Internet). The RAN 605 may be connected to the SMF 733, which may manage UE context and network handovers between Base Stations, via the N2 interface. The N2 interface may be used for transferring control plane signaling between the RAN 605 and the AMF 734.

The RU 722 may perform physical layer functions, such as employing orthogonal frequency-division multiplexing (OFDM) for data transmission. In some cases, the DU 724 may be located at a cell site and may provide real-time support for lower layers of the protocol stack, such as the radio link control (RLC) layer and the medium access control (MAC) layer. The CU may provide support for higher layers of the protocol stack, such as the service data adaptation protocol (SDAP) layer, the packet data convergence control (PDCP) layer, and the radio resource control (RRC) layer. The SDAP layer can include the highest L2 sublayer in the 5G NR protocol stack. In some embodiments, a radio access network may correspond with a single CU that connects to multiple DUs (e.g., 10 DUs), and each DU may connect to multiple RUs (e.g., 18 RUs). In this case, a single CU may manage 10 different DUs and 180 different RUs.

In some embodiments, the RAN 605 or portions of the RAN 605 may be implemented using multi-access edge computing (MEC) that allows computing and storage resources to be moved closer to user equipment. Allowing data to be processed and stored at the edge of a network that is located close to the user equipment may be necessary to satisfy low-latency application requirements. In at least one example, the DU 724 and CU-UP 726 may be executed as virtual instances within a data center environment that provides single-digit millisecond latencies (e.g., less than 2 ms) from the virtual instances to the UE 110.

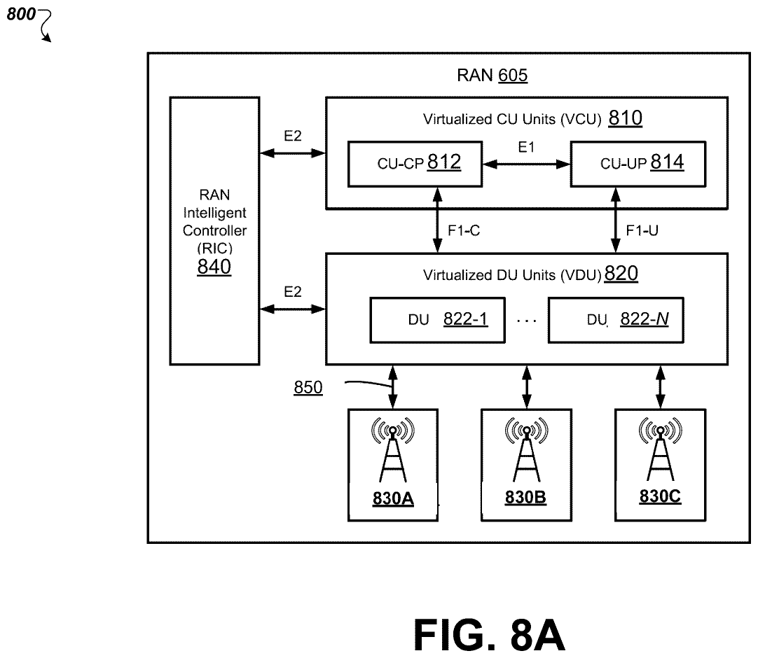

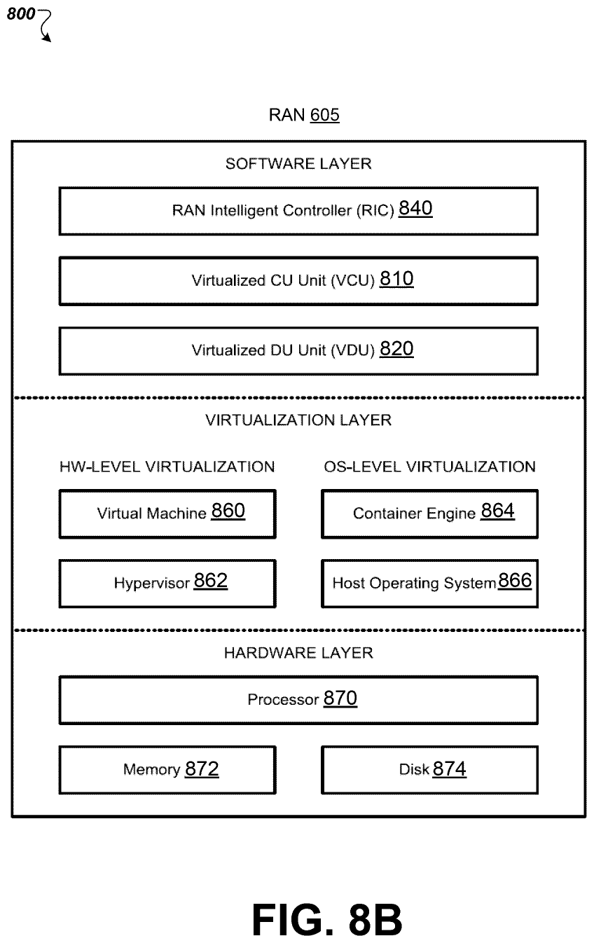

FIG. 8A depicts an example RAN 605, according to some embodiments. As shown, the RAN 605 can include virtualized CU units (vCU) 810, which can include virtualized versions (or containerized versions) of CUs. For example, vCU 810 can include a centralized unit for the control plane (CU-CP) 812 and a centralized unit for the user plane (CU-UP) 814. In one example, CUs can include a logical node configured to provide functions for the radio resource control (RRC) layer, the packet data convergence control (PDCP) layer, and the service data adaptation protocol (SDAP) layer. The CU-CP 812 can include a logical node configured to provide functions of the control plane part of the RRC and PDCP. The CU-UP 814 can include a logical node configured to provide functions of the user plane part of the SDAP and PDCP. Virtualizing the control plane and user plane functions allows the CUs to be consolidated in one or more data centers on RAN-based open interfaces.

The RAN 605 can further include virtualized DU units (vDU) 820, which can include virtualized versions (or containerized versions) of DUs 822-1 through 822-N. Each DU 822-1 through 822-N can include a logical node configured to provide functions for the radio link control (RLC) layer, the medium access control (MAC) layer, and the physical layer (PHY) layers. For example, a higher physical layer (H-PHY) can reside at the DUs and a lower physical layer (L-PHY) can reside at the RU. In some embodiments, and as shown in FIG. 8A, the RAN 605 can include a RAN intelligent controller (RIC) 840.

The RUs 830A-830C may correspond with different cells. A single DU may connect to multiple RUs via a fronthaul interface 850. The fronthaul interface 850 may provide connectivity between DUs and RUs. For example, DU 830A may connect to 18 RUs via the fronthaul interface 850. CUs may control the operation of multiple DUs via a midhaul F1 Interface that includes the F1-C and F1-U interfaces. The F1 Interface may support control plane and user plane separation, and separate the Radio Network Layer and the Transport Network Layer. In one example, the CU-CP 812 may connect to ten different DUs within the virtualized DU units 1210. In this case, the CU-CP 812 may control ten DUs and 180 RUs. A single one of DUs 822-1 through 822-N may be located at a base station or in a local data center. Centralizing a single DU at a local data center or at a single base station location instead of distributing the single DU across multiple base stations may result in reduced costs.

The CU-CP 812 may host the radio resource control (RRC) layer and the control plane part of the packet data convergence control (PDCP) layer. The E1 Interface may separate the Radio Network Layer and the Transport Network Layer. The CU-CP 812 terminates the E1 Interface connected with the centralized unit for the user plane CU-UP 814 and the F1-C interface connected with the DUs 822-1 through 822-N. The CU-UP 814 hosts the user plane part of the PDCP layer and a service data adaptation protocol (SDAP) layer. The CU-UP 814 terminates the E1 Interface connected with the centralized unit for the CU-CP 812 and the F1-U interface connected with the DUs 822-1 through 822-N. The DUs 822-1 through 822-N may handle the lower layers of the baseband processing up through the PDCP layer of the protocol stack. The interfaces F1-C and E1 may carry signaling information for setting up, modifying, relocating, and/or releasing a UE context.

The RIC 840 may control the underlying RAN elements via the E2 Interface. The E2 Interface connects the RIC 840 to the DUs 822-1 through 822-N and the centralized units including CU-CP 812 and CU-UP 814. The RIC 840 can include a real time or near-real time RIC (RT-RIC) or a non-real-time RIC (NRT-RIC). An NRT-RIC can include a logical node allowing non-real time control rather than near-real-time control and an RT-RIC can include a logical node allowing near-real-time control and optimization of RAN elements and resources on the bases of information collected from the DUs 822-1 through 822-N and the centralized units including CU-CP 812 and CU-UP 814 via the E2 Interface.

The virtualization or containerization of the DUs 822-1 through 822-N and the centralized units including CU-CP 812 and CU-UP 814 allows various deployment options that may be adjusted over time based on network conditions and network slice requirements. In at least one example, both a DU and a corresponding centralized unit may be implemented at a base station. In another example, at least one DUs 822-1 through 822-N may be implemented at a base station and the corresponding CU-UP 814 may be implemented at a local data center (LDC). In another example, at least one DUs 822-1 through 822-N and the corresponding CU-UP 814 may be implemented at an LDC. In another example, at least one DUs 822-1 through 822-N and the corresponding CU-UP 814 may be implemented at a base station, but the corresponding the CU-CP 812 may be implemented at an LDC. In another example, at least one DUs 822-1 through 822-N may be implemented at an LDC and the corresponding CU-CP 812 and CU-UP 814 may be implemented at an EDC.

In some embodiments, network slicing operations may be communicated via the E1, F1-C, and F1-U interfaces of the RAN 605. For example, CU-CP 812 may select the appropriate DU and CU-UP 814 entities to serve a network slicing request associated with a particular service level agreement (SLA).

FIG. 8B depicts an example RAN 605, according to some embodiments. As shown, the RAN 605 can include a software layer, a virtualization layer and a hardware layer. The software layer can include software applications, such as RIC 840, vCU 810, and vDU 820.

The virtualization layer can include at least one virtual machine 860, a hypervisor 862, container engine 864, and a host operating system 866. The hypervisor 862 can include a native hypervisor (or bare-metal hypervisor) or a hosted hypervisor (or type 2 hypervisor). The hypervisor 862 may provide a virtual operating platform for running at least one virtual machine 860. The hypervisor 862 can include software that creates and runs virtual machine instances. The at least one virtual machine 860 may include a set of virtual hardware devices, such as a virtual processor, a virtual memory, and a virtual disk. The at least one virtual machine 860 may include a guest operating system that has the capability to run one or more software applications, such as the RIC 840. The at least one virtual machine 860 may run the host operating system 866 upon which the container engine 864 may run. At least one virtual machine 860 may include one or more virtual processors. The container engine 864 may run on top of the host operating system 866 in order to run multiple isolated instances (or containers) on the same operating system kernel of the host operating system 866. Containers may perform virtualization at the operating system level and may provide a virtualized environment for running applications and their dependencies. The container engine 864 may acquire a container image and convert the container image into running processes. In some cases, the container engine 864 may group containers that make up an application into logical units (or pods). A pod may contain one or more containers and all containers in a pod may run on the same node in a cluster. Each pod may serve as a deployment unit for the cluster. Each pod may run a single instance of an application.

In order to scale an application horizontally, multiple instances of a pod may be run in parallel. A “replica” may refer to a unit of replication employed by a computing platform to provision or deprovision resources. Some computing platforms may run containers directly and therefore a container can include the unit of replication. Other computing platforms may wrap one or more containers into a pod and therefore a pod can include the unit of replication.

A replication controller may be used to ensure that a specified number of replicas of a pod are running at the same time. If less than the specified number of pods are running (e.g., due to a node failure or pod termination), then the replication controller may automatically replace a failed pod with a new pod. In some cases, the number of replicas may be dynamically adjusted based on a prior number of node failures. For example, if it is detected that a prior number of node failures for nodes in a cluster running a particular network slice has exceeded a threshold number of node failures, then the specified number of replicas may be increased (e.g., increased by one). Running multiple pod instances and keeping the specified number of replicas constant may prevent users from losing access to their application in the event that a particular pod fails or becomes inaccessible.

In some embodiments, a virtualized infrastructure manager not depicted may run on the RAN 605 in order to provide a centralized platform for managing a virtualized infrastructure for deploying various components of the RAN 605. The virtualized infrastructure manager may manage the provisioning of virtual machines, containers, and pods. The virtualized infrastructure manager may also manage a replication controller responsible for managing a number of pods. In some cases, the virtualized infrastructure manager may perform various virtualized infrastructure related tasks, such as cloning virtual machines, creating new virtual machines, monitoring the state of virtual machines, and facilitating backups of virtual machines.

The hardware-level components include at least one processor 870, at least one memory 872 operatively coupled with the at least one processor 870, and at least one disk 874. The at least one memory 872 can have stored therein processor-readable instructions when, when executed by the at least one processor 870, causes the at least one processor 870 to perform operations described herein. The components of the software layer may be run using the components of the hardware layer or executed using processor and storage components of the hardware layer. In some examples, at least one of the RIC 840, vCU 810, or vDU 820 may be run using the at least one processor 870, the at least one memory 872, and the at least one disk 874. In another example, at least one of the RIC 840, vCU 810, or vDU 820 may be run using a virtual processor and a virtual memory that are themselves executed or generated using the at least one processor 870, the at least one memory 872, and the at least one disk 874.

The at least one processor 870 may include one or more processing units, such as one or more CPUs and/or one or more graphics processing units (GPUs). The at least one memory 872 can include one or more types of memory (e.g., random-access memory (RAM), static RAM (SRAM), dynamic RAM (DRAM), read-only memory (ROM), electrically erasable programmable read-only memory (EEPROM), or flash memory). The at least one disk 874 can include a hard disk drive and/or a solid-state drive.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” determining,” “allocating,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method comprising:
receiving, from a cell tower corresponding to a cell of a cellular network, a set of data comprising global positioning satellite (GPS) signal data, wherein the cell tower corresponds to a fixed GPS receiver of a real-time kinematic (RTK) positioning system;
generating, based on the set of data, RTK correction data; and
causing the RTK correction data to be delivered to at least one user device of the cell using at least one delivery method, wherein the at least one user device corresponds to at least one mobile GPS receiver of the RTK positioning system, and wherein the at least one delivery method comprises at least one of:
a broadcast delivery method;
a multicast delivery method; or
a unicast delivery method.

2. The method of claim 1, wherein the GPS signal data is associated with at least one carrier wave signal received from at least one GPS satellite.

3. The method of claim 1, wherein the set of data further comprises cell tower data identifying a location of the cell tower.

4. The method of claim 3, wherein the cell tower data comprises a cell identifier (Cell-ID) of the cell.

5. The method of claim 3, wherein generating the RTK correction data comprises:
identifying the location of the cell tower from the cell tower data; and
using the GPS signal data and the location of the cell tower to generate the RTK correction data.

6. The method of claim 1, wherein causing the RTK correction data to be delivered to the at least one user device comprises causing a positioning application programming interface (API) to broadcast the RTK correction data to the at least one user device.

7. The method of claim 6, wherein causing the positioning API to deliver the RTK correction data to the at least one user device comprises providing a set of delivery data to the positioning API, and wherein the set of delivery data comprises the RTK correction data and cell tower data identifying a location of the cell tower.

8. A system comprising:
a memory; and
at least one processing device, operatively coupled with the memory, to:
receive, from a cell tower corresponding to a cell of a cellular network, a set of data comprising global positioning satellite (GPS) signal data, wherein the cell tower corresponds to a fixed GPS receiver of a real-time kinematic (RTK) positioning system;
generate, based on the set of data, RTK correction data; and
cause the RTK correction data to be delivered to at least one user device of the cell using at least one delivery method, wherein the at least one user device corresponds to at least one mobile GPS receiver of the RTK positioning system, and wherein the at least one delivery method comprises at least one of:
a broadcast delivery method;
a multicast delivery method; or
a unicast delivery method.

9. The system of claim 8, wherein the GPS signal data is associated with at least one carrier wave signal received from at least one GPS satellite.

10. The system of claim 8, wherein the set of data further comprises cell tower data identifying a location of the cell tower.

11. The system of claim 10, wherein the cell tower data comprises a cell identifier (Cell-ID) of the cell tower.

12. The system of claim 10, wherein, to generate the RTK correction data, the at least one processing device is to:
identify the location of the cell tower from the cell tower data; and
use the GPS signal data and the location of the cell tower to generate the RTK correction data.

13. The system of claim 8, wherein, to cause the RTK correction data to be delivered to the at least one user device, the at least one processing device is to cause a positioning application programming interface (API) to deliver the RTK correction data to the at least one user device.

14. The system of claim 13, wherein, to cause the positioning API to deliver the RTK correction data to the at least one user device, the at least one processing device is to provide a set of delivery data to the positioning API, and wherein the set of delivery data comprises the RTK correction data and cell tower data identifying a location of the cell tower.

15. A system comprising:
a memory; and
at least one processing device, operatively coupled with the memory, to:
obtain global positioning satellite (GPS) signal data;
send, to a component of a cellular network, a set of data comprising the GPS signal data;
receive, from the component, real-time kinematic (RTK) correction data generated based on the set of data; and
deliver the RTK correction data to at least one user device of the cellular network using at least one delivery method, wherein the at least one user device corresponds to at least one mobile GPS receiver of an RTK positioning system, and wherein the at least one delivery method comprises at least one of:
a broadcast delivery method;
a multicast delivery method; or
a unicast delivery method.

16. The system of claim 15, wherein the GPS signal data is associated with at least one carrier wave signal received from at least one GPS satellite.

17. The system of claim 15, wherein the set of data further comprises cell tower data identifying a location of the cell tower.

18. The system of claim 17, wherein the cell tower data comprises a cell identifier (Cell-ID) of the cell tower.

19. The system of claim 8, wherein, to deliver the RTK correction data to the at least one user device, the at least one processing device is to cause a positioning application programming interface (API) to deliver the RTK correction data to the at least one user device.

20. The system of claim 19, wherein, to cause the positioning API to deliver the RTK correction data to the at least one user device, the at least one processing device is to provide a set of delivery data to the positioning API, and wherein the set of deliver data comprises the RTK correction data and cell tower data identifying a location of the cell tower.
